(19) United States
(12) Patent Application Publication
(10) Pub. No.: US 2026/0140073 A1
(43) Pub. Date: May 21, 2026

(54) SYSTEM AND METHOD FOR MINERAL COMPOSITION ANALYSIS USING X-RAY DIFFRACTION BASED ON MACHINE LEARNING UTILIZING DOMAIN KNOWLEDGE

(71) Applicant: KONGJU NATIONAL UNIVERSITY INDUSTRY-UNIVERSITY COOPERATION FOUNDATION, Gongju-si (KR)

(72) Inventors: Hong Keun Jin, Gunpo-si (KR); Ju Young Park, Gongju-si (KR); Kyung Book Lee, Sejong-si (KR)

(21) Appl. No.: 19/441,775

(22) Filed: Jan. 6, 2026

Related U.S. Application Data
(63) Continuation of application No. PCT/KR2023/011410, filed on Aug. 3, 2023.

(30) Foreign Application Priority Data
Jul. 6, 2023 (KR) 10-2023-0087820

(51) Int. Cl. G01N 23/20; G06N 3/0985

(52) U.S. Cl. CPC G01N 23/20; G06N 3/0985; G01N 2223/616

(57) ABSTRACT

A system and method for X-ray diffraction composition analysis based on machine learning utilizing domain knowledge is proposed. The method for X-ray diffraction composition analysis based on machine learning utilizing domain knowledge may include inputting X-ray diffraction data of a mineral; preprocessing the input X-ray diffraction data by normalizing the data per dataset, and generating a clustering model by using the preprocessed X-ray diffraction data. The method may also include generating a mineral composition analysis model by using the preprocessed X-ray diffraction data, and classifying new X-ray diffraction data into usual composition data or unusual composition data using the clustering model after inputting and preprocessing the new X-ray diffraction data. The method may further include estimating the mineral composition of the new X-ray diffraction data classified as the usual composition data through analysis using the mineral composition analysis model.

### CROSS-REFERENCE TO RELATED APPLICATIONS

This application is a continuation application, and claims the benefit under 35 U.S.C. § 120 and § 365 of PCT Application No. PCT/KR2023/011410 filed on Aug. 3, 2023, which claims priority to Korean Patent Application No. 10-2023-0087820 filed on Jul. 6, 2023, both of which are hereby incorporated by reference in their entirety.

### BACKGROUND

### Technical Field

The present disclosure relates to a system and method for mineral composition analysis using X-ray diffraction based on machine learning utilizing domain knowledge.

### Description of Related Technology

Due to issues concerning global warming and energy security, the importance of developing Gas Hydrate, which is widely distributed across the globe with an estimated reserve of 3,000 trillion cubic meters, is increasing. In particular, Korea's net energy import dependency was 88.1% as of 2010, resulting in the import of most energy from overseas. Accordingly, the importance of gas hydrates reserved around Korea is also high. Gas hydrate is characterized by being eco-friendly as its main component is methane, which emits less carbon dioxide than traditional resources such as coal and oil. However, due to characteristics different from traditional resources, research on geological information and flow characteristics of the reservoir is required for commercial production of gas hydrate.

Mineral composition data provides information such as the formation environment and origin of sediments. Furthermore, composition analysis of constituent minerals is important for the characterization of petroleum reservoirs. Such mineral composition data can be obtained through X-ray diffraction (XRD) experimental analysis. The X-ray diffraction experiment measures the intensity of diffracted X-rays by injecting X-rays into a sample powdered to 10 μm or less. The X-ray diffraction intensity obtained from the experiment is analyzed by an expert using analysis software to determine the mineral composition. Individual minerals possess characteristic intensities depending on the incidence angle of X-rays, but when composed of various minerals such as sediments, the pattern is complex, leading to a high dependence on experts for interpretation. Furthermore, when analyzing a large volume of samples, there is a significant limitation in the time consumed due to repetitive work.

### SUMMARY

The present disclosure is directed to providing a system and method for mineral composition analysis using X-ray diffraction based on machine learning utilizing domain knowledge, which classifies X-ray diffraction data of sediments into usual composition data or unusual composition data using a clustering model, estimates the composition value using a mineral composition analysis model in the case of the usual composition data, and allows an expert to analyze the unusual composition data in the case of the unusual composition data.

According to an aspect of the present disclosure, a method for mineral composition analysis using X-ray diffraction based on machine learning utilizing domain knowledge, performed by an X-ray diffraction mineral composition analysis system, is disclosed.

The method for mineral composition analysis using X-ray diffraction based on machine learning utilizing domain knowledge according to an embodiment of the present disclosure comprises: inputting X-ray diffraction data of a mineral; preprocessing the input X-ray diffraction data by normalizing the data for each dataset; generating a clustering model by using the preprocessed X-ray diffraction data; generating a mineral composition analysis model by using the preprocessed X-ray diffraction data; classifying new X-ray diffraction data into usual composition data or unusual composition data using the clustering model after inputting and preprocessing the new X-ray diffraction data; and estimating the mineral composition of the new X-ray diffraction data classified as the usual composition data through analysis using the mineral composition analysis model.

The preprocessing step may include normalizing intensity values contained in the X-ray diffraction data using min-max scaling on a per-sample basis.

The step of generating the clustering model includes: separating the pre-processed X-ray diffraction data into training and validation data and test data; training the clustering model with the training and validation data; selecting an unusual composition criterion for performance evaluation of the clustering model using the training and validation data; classifying the test data into usual composition data and unusual composition data according to the selected unusual composition criterion using the trained clustering model; generating a confusion matrix using the classification result; selecting precision as an evaluation metric among confusion matrix performance evaluation metrics for determining the optimal number of clusters; and determining the number of clusters with the highest precision of the generated confusion matrix as the optimal number of clusters to generate the optimized clustering model.

The step of generating the mineral composition analysis model includes: separating the pre-processed X-ray diffraction data into training data, validation data, and test data; performing deep learning with the training data and the validation data; and optimizing hyper-parameters of the deep learning model generated through the deep learning performance using the validation data and the test data to generate an optimized mineral composition analysis model.

New X-ray diffraction data classified as the unusual composition data is analyzed by an expert and the mineral composition is estimated.

The X-ray diffraction data comprises intensity values and mineral composition values.

According to another aspect of the present disclosure, a system for mineral composition analysis using X-ray diffraction based on machine learning utilizing domain knowledge is disclosed.

A system for mineral composition analysis using X-ray diffraction based on machine learning utilizing domain knowledge according to an embodiment of the present disclosure comprises a memory for storing instructions; and a processor for executing the instructions, wherein the instructions are configured to perform an X-ray diffraction composition analysis method comprising: inputting X-ray diffraction data of a mineral; preprocessing the input X-ray diffraction data by normalizing the data for each dataset; generating a clustering model by using the preprocessed X-ray diffraction data; generating a mineral composition analysis model by using the preprocessed X-ray diffraction data; classifying new X-ray diffraction data into usual composition data or unusual composition data using the clustering model after inputting and preprocessing the new X-ray diffraction data; and estimating the mineral composition of the new X-ray diffraction data classified as the usual composition data through analysis using the mineral composition analysis model.

The system and method for mineral composition analysis using X-ray diffraction based on machine learning utilizing domain knowledge according to an embodiment of the present disclosure can classify X-ray diffraction data of sediments into usual composition data or unusual composition data using a clustering model, estimate the composition value using a mineral composition analysis model in the case of the usual composition data, and allow an expert to analyze the unusual composition data in the case of the unusual composition data.

### BRIEF DESCRIPTION OF THE DRAWINGS

FIG. 1 is a flowchart schematically illustrating a method for mineral composition analysis using X-ray diffraction based on machine learning utilizing domain knowledge, performed by an X-ray diffraction mineral composition analysis system according to an embodiment of the present disclosure.

FIG. 2 is a flowchart schematically illustrating the detailed steps of step S300 of FIG. 1.

FIG. 3 is a flowchart schematically illustrating the detailed steps of step S400 of FIG. 1.

FIGS. 4 to 11 are diagrams for describing the method for mineral composition analysis using X-ray diffraction based on machine learning utilizing domain knowledge according to the embodiment of the present disclosure in FIG. 1.

FIG. 12 is a diagram schematically illustrating the configuration of a system for mineral composition analysis using X-ray diffraction based on machine learning utilizing domain knowledge according to an embodiment of the present disclosure.

### DETAILED DESCRIPTION

As used herein, the singular forms include the plural forms unless the context clearly dictates otherwise. In the present specification, terms such as “comprising” or “including” should not be construed as necessarily including all of the various elements or steps described in the specification, but rather as including some of those elements or steps, or as being capable of including additional elements or steps. Further, the terms such as “ . . . unit” or “module” described in the specification mean a unit that processes at least one function or operation, and can be implemented in hardware or software or a combination of hardware and software.

Hereinafter, various embodiments of the present disclosure will be described in detail with reference to the accompanying drawings.

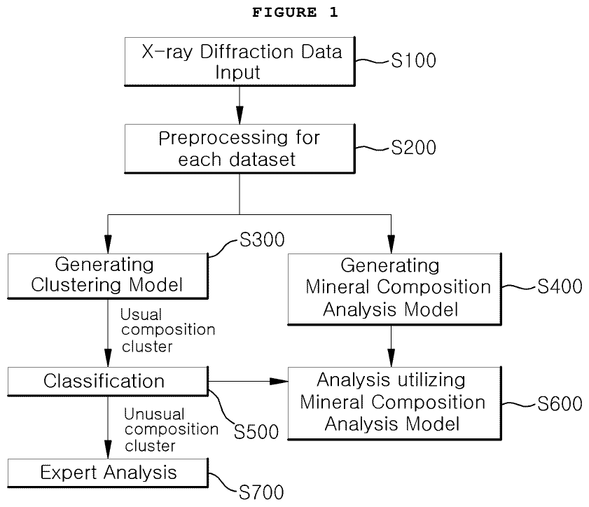

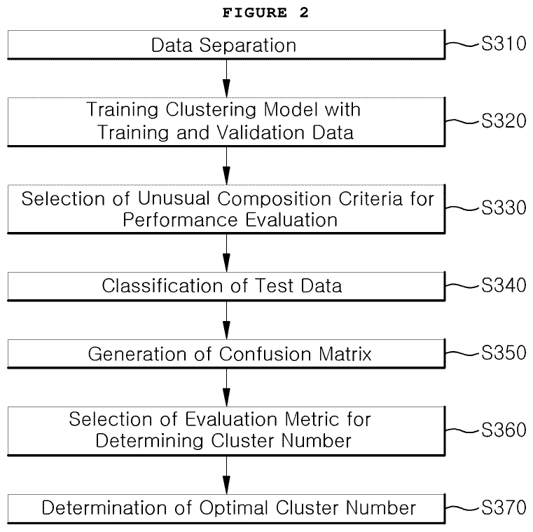

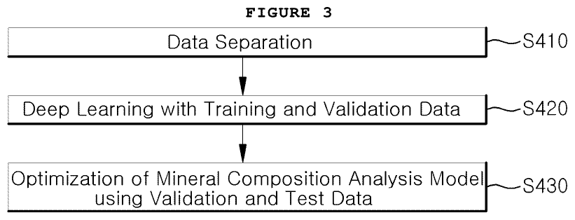

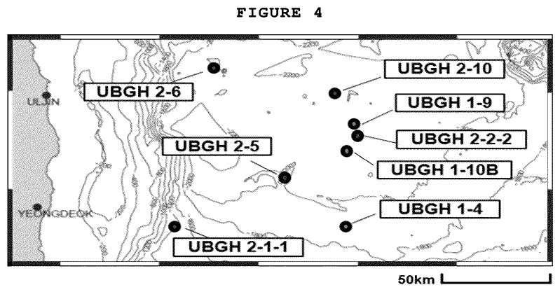

FIG. 1 is a flowchart schematically illustrating a method for mineral composition analysis using X-ray diffraction based on machine learning utilizing domain knowledge, performed by the X-ray diffraction mineral composition analysis system according to an embodiment of the present disclosure, FIG. 2 is a flowchart schematically illustrating the detailed steps of step S300 of FIG. 1, FIG. 3 is a flowchart schematically illustrating the detailed steps of step S400 of FIG. 1, and FIGS. 4 to 11 are diagrams for describing the method for mineral composition analysis using X-ray diffraction based on machine learning utilizing domain knowledge according to the embodiment of the present disclosure in FIG. 1. Hereinafter, the method for mineral composition analysis using X-ray diffraction based on machine learning utilizing domain knowledge according to the embodiment of the present disclosure will be described, focusing on FIG. 1, with reference to FIGS. 2 to 11.

In step S100, the X-ray diffraction mineral composition analysis system receives X-ray diffraction data of a mineral.

FIG. 4 shows the locations of eight boreholes for the UBGH-1 and UBGH-2 projects conducted in the Ulleung Basin of the East Sea. In the embodiment of the present disclosure, X-ray diffraction data of 488 datasets obtained through the UBGH-1 and UBGH-2 large-scale drilling exploration projects conducted in the Ulleung Basin of the East Sea in 2007 and 2010 were used, and this data was provided by the Gas Hydrate R&D Organization. This data is sediment data obtained from a total of eight boreholes, the locations of which are as shown in FIG. 4, and the number of data points per borehole is as shown in the table 1 below.

TABLE 1

| | UBGH-1 | | | UBGH-2 | | | | |
|---|---|---|---|---|---|---|---|---|
| Well name | 1-4 | 1-9 | 1-10B | 2-1_1 | 2-2_2 | 2-5 | 2-6 | 2-10 |
| Samples | 17 | 40 | 37 | 97 | 55 | 87 | 87 | 74 |

Out of the total 488 data sets, 439 (90%) were used for model training, and the remaining 49 (10%) were used for testing.

The X-ray diffraction data is composed of 3,100 intensity values (input layer) configured at intervals of 0.02° in the incidence angle range of 3.01° to 64.99°, and 12 mineral composition values (output layer) analyzed from them. Here, the 12 minerals are quartz, albite, opal-A, calcite, muscovite, dolomite, chlorite, kaolinite, illite, pyrite, NaCl, and K-feldspar.

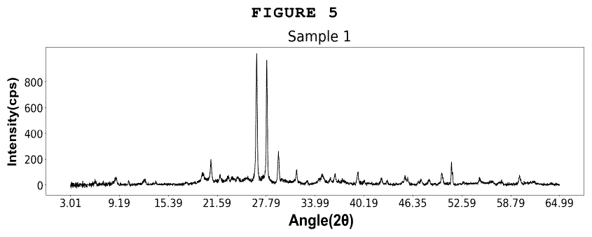

For example, the intensity values according to the incidence angle of the 1st dataset are as shown in FIG. 5, and the mineral composition values are as shown in the table 2 below.

TABLE 2

| Minerals | Quartz | Albite | K-feldspar | Opal-A | Calite | Muscovite |
|---|---|---|---|---|---|---|
| Values | 19.3 | 33.7 | 3.1 | 11.9 | 6 | 9.1 |

| Minerals | Dolomite | Chlorite | Kaolinite | Illite | Pyrite | NaCl |
|---|---|---|---|---|---|---|
| Values | 0 | 1.3 | 2.8 | 9.1 | 1.9 | 1.8 |

In step S200, the X-ray diffraction mineral composition analysis system preprocesses the received X-ray diffraction data by normalizing the data per dataset.

For example, the intensity values of the received X-ray diffraction data may be preprocessed using the min-max scaling mathematical formula 1 below.

$${X}_{m s} = \frac{{X}_{j , i} - {X}_{min , j}}{{X}_{max , j} - {X}_{min , j}} \qquad [ Formula 1 ]$$

Here, Xₘₛ represents the intensity value normalized through min-max scaling, and X_{max,j} and X_{min,j} represent the maximum and minimum intensity values for the j-th dataset, respectively.

That is, the X-ray diffraction composition analysis system according to the embodiment of the present disclosure preprocesses the input X-ray diffraction data per dataset. This is because the absolute peak size and exact position are not important for interpretation, and differences occur due to the mineralogical characteristics and experimental errors of the data, and the ratio and tendency of the intensity values according to the incidence angle within one dataset are important. Therefore, in the present disclosure, the X-ray diffraction data is normalized between 0 and 1 to match the scale.

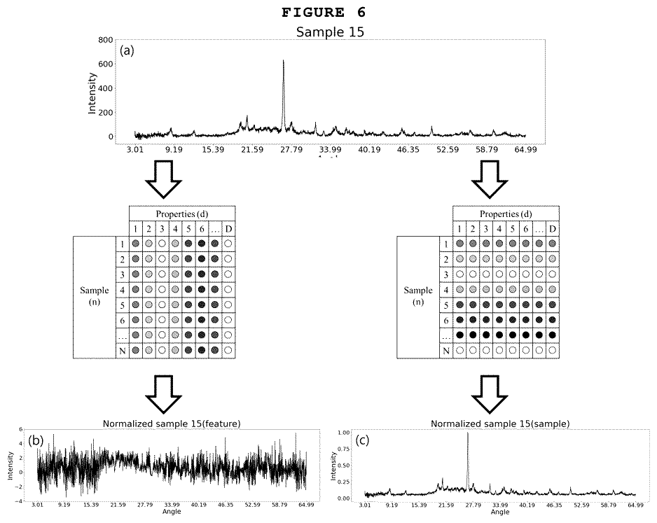

FIG. 6 shows the shape of X-ray diffraction data according to the preprocessing method. Generally, it can be confirmed that the shape of the raw data (a) is completely damaged into the form of (b) during preprocessing by parameter which is used in machine learning, and when the min-max scaler per dataset is applied, it can be seen that the shape of the raw data is maintained as in (c) and the scale is also corrected to 0 to 1. Therefore, it is determined that applying min-max scaling per dataset only for X-ray diffraction data is appropriate.

In step S300, the X-ray diffraction mineral composition analysis system generates a clustering model using the preprocessed X-ray diffraction data.

Hereinafter, the detailed steps of step S300 will be described with reference to FIG. 2.

In step S310, the X-ray diffraction mineral composition analysis system separates the preprocessed X-ray diffraction data into training and validation data and test data.

In step S320, the X-ray diffraction mineral composition analysis system trains the clustering model with the training and validation data.

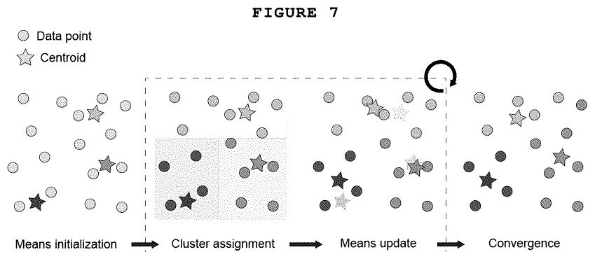

FIG. 7 shows the process of the k-means clustering algorithm, which is one type of clustering algorithm. Referring to FIG. 7, the k-means clustering algorithm is a method of predetermining the number of clusters K, assigning data to each cluster based on an initial centroid, and repeatedly updating the average of the clusters until the centroid no longer changes, thereby classifying the data closest to the centroid into one cluster. Since the result value changes depending on the number of clusters, it is important to select the optimal number of clusters suitable for the purpose.

In step S330, the X-ray diffraction mineral composition analysis system selects a specific composition criterion for performance evaluation of the clustering model using the training and validation data.

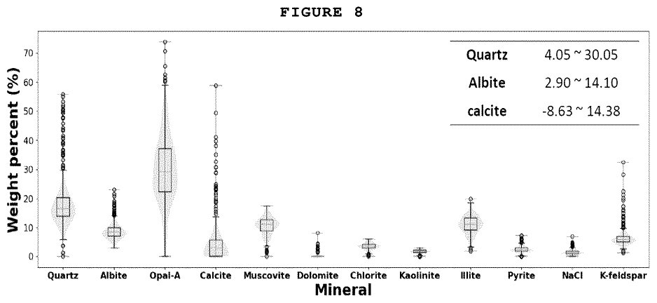

For example, FIG. 8 shows the boxplot for the composition values of 12 minerals and the range of composition values of the usual composition data identified using the training and validation data. If the data does not fall within the corresponding range, it is classified as unusual composition data.

In step S340, the X-ray diffraction mineral composition analysis system classifies the test data into usual composition data and unusual composition data using the trained clustering model.

In step S350, the X-ray diffraction mineral composition analysis system generates a confusion matrix using the classification result.

In step S360, the X-ray diffraction mineral composition analysis system selects precision among the confusion matrix performance evaluation indicators to determine the optimal number of clusters.

As indicators for quantitatively analyzing the clustering result, recall and precision of the confusion matrix are used, and can be expressed by the following mathematical formula 2.

$$( a ) Recall = \frac{T P}{T P + F N} ( b ) Precision = \frac{TP}{TP + FP} \qquad [ Formula 2 ]$$

That is, recall is the ratio of the number of data points accurately predicted as usual composition data among the actual usual composition data, and precision is the ratio of the number of data points that are actually usual composition data among the number of data points predicted as usual composition data.

Considering the purpose of the present disclosure, where identifying the existence of unusual composition data within the usual composition cluster is important, it is reasonable to determine the number of clusters based on precision, which represents the ratio of actual usual composition data among the classified data.

In step S370, the X-ray diffraction mineral composition analysis system determines the number of clusters with the highest precision in the generated confusion matrix as the optimal number of clusters to generate an optimized clustering model.

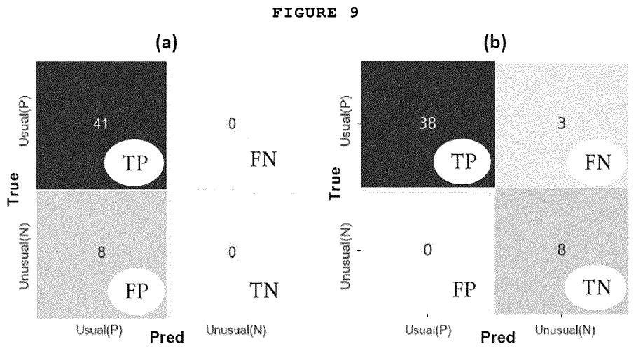

FIG. 9 shows the confusion matrix for the 49 test datasets obtained from the Ulleung Basin. Referring to (a) and (b) of FIG. 9, the recall was 100% when the number of clusters was 3 and 92.7% when it was 5, and the precision was 83.7% when the number of clusters was 3 and 100% when it was 5. Although the optimal number of clusters should be 3 when considering recall, since the appropriate indicator for the present disclosure is precision, the optimal number of clusters can be 5.

In step S400, the X-ray diffraction mineral composition analysis system generates a mineral composition analysis model using the preprocessed X-ray diffraction data.

Hereinafter, the detailed steps of step S400 will be described with reference to FIG. 3.

In step S410, the X-ray diffraction mineral composition analysis system separates the preprocessed X-ray diffraction data into training data, validation data, and test data.

In step S420, the X-ray diffraction mineral composition analysis system performs deep-learning using the training data and the validation data.

The table below shows the mean and deviation of the coefficient of determination and the mean absolute error according to the preprocessing method, using CNN (convolutional neural network), one of the deep-learning algorithms. Comparing Feature_CNN and Sample_CNN, which are the cases where normalization by parameter and normalization by dataset were performed, respectively, a coefficient of determination of 0.757 is shown when normalizing by dataset compared to normalization by parameter, confirming that normalization by dataset is reasonable.

TABLE 3

| | R² | Avg. MAE | Std. MAE |
|---|---|---|---|
| Feature_CNN | 0.518 | 1.16 | 0.88 |
| Sample_CNN | 0.757 | 0.68 | 0.45 |

In step S430, the X-ray diffraction mineral composition analysis system generates a mineral composition analysis model by optimizing the Hyper parameters of the deep-learning model generated through the deep-learning performance, using the validation and test data.

Referring again to FIG. 1, steps S500 to S700 will be described.

In step S500, the X-ray diffraction mineral composition analysis system receives new X-ray diffraction data, preprocesses it, and then classifies the preprocessed new X-ray diffraction data into usual composition data or unusual composition data using the generated clustering model.

In step S600, the X-ray diffraction mineral composition analysis system estimates the mineral composition of the new X-ray diffraction data classified as the usual composition data using the generated mineral composition analysis model.

In step S700, the mineral composition of the new X-ray diffraction data classified as unusual mineral composition data is analyzed by an expert and the mineral composition is estimated.

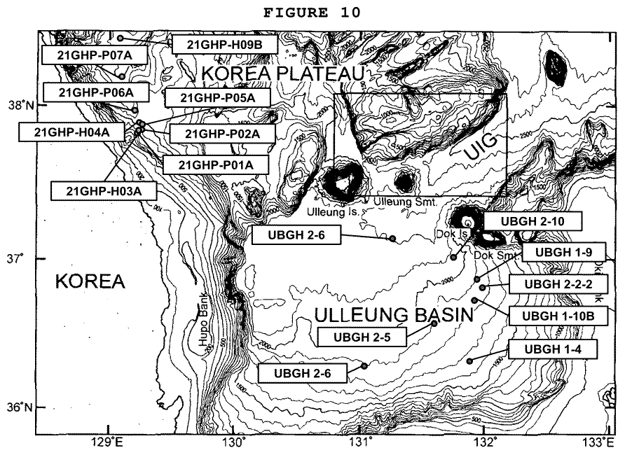

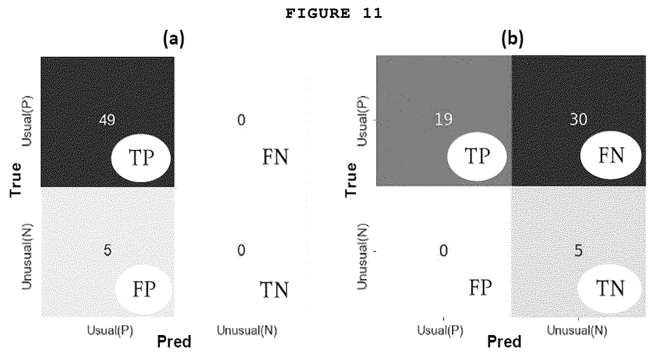

FIG. 10 shows the locations of the UBGH-1, UBGH-2 projects, and the Korea Plateau boreholes, and FIG. 11 shows the confusion matrix results for additional validation data from the Korea Plateau. The applicability and scalability of the clustering model to additional data in nearby areas was determined by utilizing 54 data sets obtained from the Korea Plateau, located on the northern periphery of the Ulleung Basin as shown in FIG. 10. As shown in FIG. 11, similar to the previous results, when the number of clusters was 5, it showed 100% precision compared to when it was 3, confirming that there is no unusual composition data within the usual composition cluster.

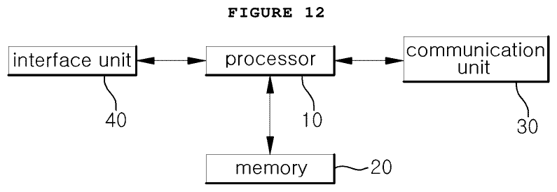

FIG. 12 is a diagram schematically illustrating the configuration of a system for mineral composition analysis using X-ray diffraction based on machine learning utilizing domain knowledge according to an embodiment of the present disclosure.

Referring to FIG. 12, the system for mineral composition analysis using X-ray diffraction based on machine learning utilizing domain knowledge according to an embodiment of the present disclosure comprises a processor (10), a memory (20), a communication unit (30), and an interface unit (40).

The processor (10) may be a CPU or a semiconductor device that executes processing instructions stored in the memory (20).

The memory (20) may include various types of volatile or non-volatile storage media. For example, the memory (20) may include ROM, RAM, and the like.

For example, the memory (20) may store instructions for performing the method for mineral composition analysis using X-ray diffraction based on machine learning utilizing domain knowledge according to an embodiment of the present disclosure.

The communication unit (30) is a means for transmitting and receiving data to and from other devices through a communication network.

The interface unit (40) may include a network interface for connecting to a network and a user interface.

Meanwhile, the constituent elements of the above-described embodiment can be easily understood from a process perspective. That is, each constituent element can be understood as a respective process. In addition, the process of the above-described embodiment can be easily understood from the perspective of the constituent elements of the device.

Furthermore, the technical contents described above can be embodied in the form of program instructions that can be executed through various computer means and recorded on a computer-readable medium. The computer-readable medium may include program instructions, data files, data structures, etc., alone or in combination. The program instructions recorded on the medium may be specially designed and configured for the embodiments or may be well-known and usable to those skilled in the art of computer software. Examples of computer-readable recording media include magnetic media such as hard disks, floppy disks, and magnetic tapes, optical recording media such as CD-ROMs and DVDs, magneto-optical media such as floptical disks, and hardware devices specially configured to store and execute program instructions, such as ROM, RAM, and flash memory. Examples of program instructions include machine language codes created by a compiler as well as high-level language codes that can be executed by a computer using an interpreter or the like. The hardware device may be configured to operate as one or more software modules to perform the operations of the embodiments, and vice versa.

The embodiments of the present disclosure described above are disclosed for illustrative purposes, and various modifications, changes, and additions will be possible within the spirit and scope of the present disclosure by those of ordinary skill in the art to which the present disclosure belongs, and such modifications, changes, and additions should be regarded as falling within the scope of the claims below.

1. A method for mineral composition analysis using X-ray diffraction based on machine learning utilizing domain knowledge performed by an X-ray diffraction composition analysis system, the method comprising:
Inputting X-ray diffraction data of a mineral;
preprocessing the input X-ray diffraction data by normalizing the data for each dataset;
generating a clustering model by using the preprocessed X-ray diffraction data;
generating a mineral composition analysis model by using the preprocessed X-ray diffraction data;
classifying new X-ray diffraction data into usual composition data or unusual composition data using the clustering model after inputting and preprocessing the new X-ray diffraction data; and
estimating a mineral composition of the new X-ray diffraction data classified as the usual composition data through analysis using the mineral composition analysis model.

2. The method of claim 1, wherein the preprocessing comprises:
preprocessing an intensity values included in the X-ray diffraction data for each dataset using min-max scaling.

3. The method of claim 1, wherein generating the clustering model comprises:
separating the preprocessed X-ray diffraction data into training and validation data and test data;
training a clustering model with the training and validation data;
selecting specific composition criteria for performance evaluation of the clustering model using the training and validation data;
classifying the test data into usual composition data and unusual composition data according to the selected specific composition criteria using the trained clustering model;
generating a confusion matrix using classification results;
selecting precision among confusion matrix performance evaluation indicators for determining an optimal number of clusters; and
determining the number of clusters with the highest precision of the generated confusion matrix as the optimal number of clusters to generate an optimized clustering model.

4. The method of claim 1, wherein generating the mineral composition analysis model comprises:
separating the preprocessed X-ray diffraction data into training data, validation data, and test data;
performing deep-learning with the training data and the validation data; and
optimizing hyperparameters of a deep-learning model generated through the deep-learning using the validation data and the test data to generate an optimized mineral composition analysis model.

5. The method of claim 1, wherein the new X-ray diffraction data classified as unusual composition data is analyzed by an expert to estimate mineral composition.

6. The The method of claim 1, wherein the X-ray diffraction data comprises intensity values and mineral composition values.

7. A system for mineral composition analysis using X-ray diffraction based on machine learning utilizing domain knowledge, comprising:
a memory for storing instructions; and
a processor for executing the instructions,
wherein the instructions are configured to perform an X-ray diffraction composition analysis method comprising:
inputting X-ray diffraction data of a mineral;
preprocessing the inputted X-ray diffraction data by normalizing the data per dataset;
generating a clustering model by using the preprocessed X-ray diffraction data;
generating a mineral composition analysis model by using the preprocessed X-ray diffraction data;
classifying new X-ray diffraction data into usual composition data or unusual composition data using the clustering model after inputting and preprocessing the new X-ray diffraction data; and
estimating the mineral composition of the new X-ray diffraction data classified as the usual composition data through analysis using the mineral composition analysis model.
